(19) United States
(12) Patent Application Publication
(10) Pub. No.: US 2016/0273456 A1
(43) Pub. Date: Sep. 22, 2016

(54) GAS TURBINE SYSTEM AND METHOD

(71) Applicants: Hua ZHANG, (US); Wenjie WU, (US); Yongjiang HAO, (US); GENERAL ELECTRIC COMPANY, Schenectady, NY (US)

(72) Inventors: Hua Zhang, Greer, SC (US); Wenjie Wu, Shanghai (CN); Yongjiang Hao, Shanghai (CN)

(73) Assignee: General Electric Company, Schenectady, NY (US)

(21) Appl. No.: 14/768,431

(22) PCT Filed: Oct. 16, 2013
(86) PCT No.: PCT/CN2013/085282

§ 371 Date: Aug. 17, 2015

(51) Int. Cl. F02C 7/32; F02C 7/22; F02C 3/04; F02C 7/36

(52) U.S. Cl. CPC F02C 7/32; F02C 7/36; F02C 7/22; F02C 3/04; F05D 2220/7642; F05D 2220/32

(57) ABSTRACT

A fuel supply system includes a first fuel gas compressor coupled to a fuel gas compressor shaft and configured to pressurize a fuel for a gas turbine system. A clutch is coupled to the fuel gas compressor shaft and is configured to selectively engage the fuel gas compressor shaft with a turbine shaft of the gas turbine system. An electromechanical machine is configured to operator as a motor to drive the fuel gas compressor shaft or to operate as a generator driven by the turbine shaft to generator power, based on an operating condition of the gas turbine system.

### CROSS-REFERENCE TO RELATED APPLICATIONS

This application claims priority from and the benefit of PCT Application No. PCT/CN2013/085282, filed on Oct. 16, 2013, entitled “Gas Turbine System and Method of Operation,” which is herein incorporated by reference in its entirety.

### BACKGROUND OF THE INVENTION

The subject matter disclosed herein relates to power generation systems, and, more particularly, to a fuel gas compressor system.

Syngas fuel is widely used for power plants with gas turbines systems. For example, the gas turbine system may include one or more combustors, which may combust the fuel to produce hot combustion gases. The resulting hot combustion gases may then be used to drive one or more turbines. Generally, the fuel supplied to the combustor of the gas turbine system is supplied at an elevated pressure. However, the pressure of the fuel may be more difficult to control during transient conditions, such as startup of the gas turbine system.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a gas turbine system includes a compressor configured to compress air and at least one fuel gas compressor configured to compress fuel. A combustor is configured to combust a mixture of the air and the fuel into combustion products. A turbine is configured to rotate a shaft using the combustion products, and the shaft is coupled to the compressor, the at least one fuel gas compressor, and the turbine. An electromechanical machine is configured to operate as a motor to drive the shaft or to operate as a generator driven by the shaft to generate power, based on an operating condition of the gas turbine system.

In a second embodiment, a fuel supply system includes a first fuel gas compressor coupled to a fuel gas compressor shaft and configured to pressurize a fuel for a gas turbine system. A clutch is coupled to the fuel gas compressor shaft and is configured to selectively engage the fuel gas compressor shaft with a turbine shaft of the gas turbine system. An electromechanical machine is configured to operator as a motor to drive the fuel gas compressor shaft or to operate as a generator driven by the turbine shaft to generator power, based on an operating condition of the gas turbine system.

In a third embodiment, a method includes operating an electromechanical machine as a motor to drive a shaft of a fuel gas compressor. An operating parameter related to the shaft is detected by a sensor. A controller determines if the operating parameter is within a range. The method includes operating the electromechanical machine as an auxiliary generator driven by the shaft when the operating condition is within the range.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a gas turbine system, in accordance with aspects of the present disclosure;

FIG. 2 is a schematic diagram of an embodiment of the gas turbine system of FIG. 1, in accordance with aspects of the present disclosure;

FIG. 3 is a schematic diagram of an embodiment of a fuel supply system of the gas turbine system of FIG. 1, in accordance with aspects of the present disclosure;

FIG. 4 is a flow chart of an embodiment of a method to operate a gas turbine system, in accordance with aspects of the present disclosure; and

FIG. 5 is a flow chart of an embodiment of a method to operate a gas turbine system, in accordance with aspects of the present disclosure.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems and methods to pressurize a fuel for a gas turbine system. During operation, gas turbines combust a mixture of air and fuel (e.g., a gas or vapor-phase fuel) into combustion products. The combustion products force blades of a turbine to rotate, thereby driving a shaft into rotation. The rotating shaft may drive one or more fuel gas compressors, which, in turn, pressurize the fuel (e.g., fuel gas) for the gas turbine. During operation, the rotating speed of the shaft enables the fuel gas compressors to pressurize the fuel to a desired pressure for delivery to the gas turbine. However, during start-up of the gas turbine, the rotating speed of the turbine shaft may be too low to adequately compress the fuel. In certain embodiments, liquid fuels may be routed to the gas turbine during initial stages of the startup process, and fuel gases may be introduced once the speed of the turbine shaft reaches a desired speed. Unfortunately, liquid fuel-based start-ups may be difficult and relatively expensive.

To use fuel (e.g., fuel gas) throughout the startup process, presently disclosed embodiments of a gas turbine system may include an electromechanical machine (EM) (e.g., a synchronized motor) to operate as a motor that drives a fuel gas compressor when the rotating speed of the shaft of the gas turbine system is low. As the gas turbine system continues to start up, the rotational speed of the shaft gradually increases. Once the speed of the shaft reaches a desired speed (e.g., a speed sufficiently high to pressurize fuel gas), the EM may be operated as a generator driven by the shaft, thereby producing electrical power. The selective operation of the EM as either a motor or a generator, e.g., based on an operating condition or operating mode of the gas turbine system, may improve the efficiency and operability of the gas turbine system. In particular, because the EM may operate as a generator (e.g., an auxiliary generator) during steady-state operation, the size of main generators or loads may be decreased.

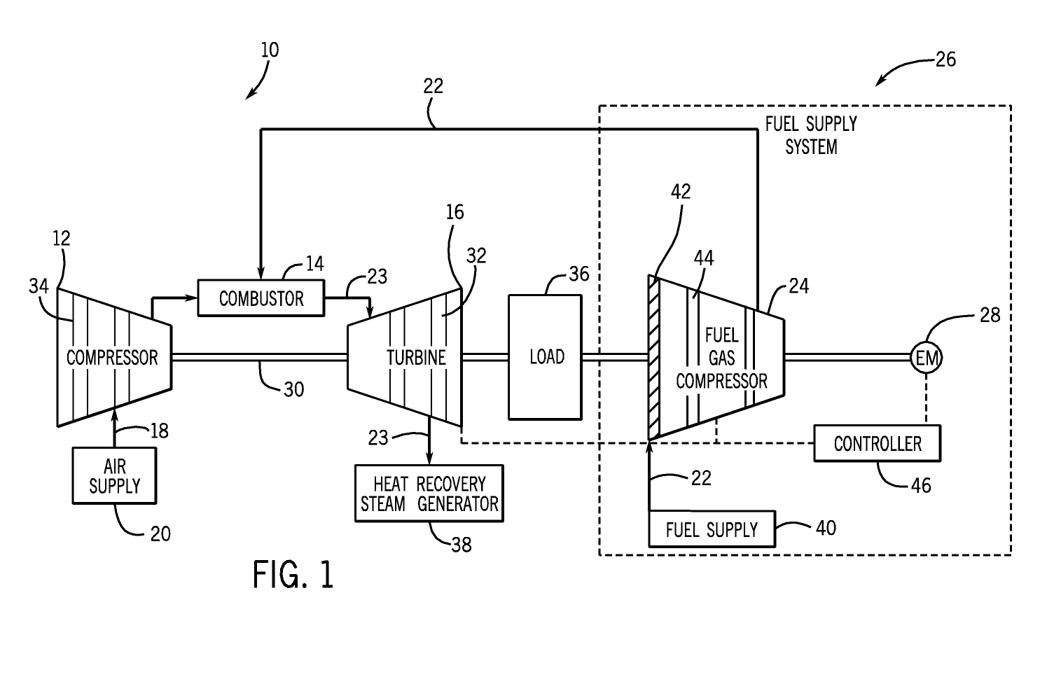

Turning now to the figures, FIG. 1 is a schematic diagram of an embodiment of a gas turbine system 10. The gas turbine system 10 includes a compressor 12, a combustor 14, and a turbine 16. The compressor 12 receives an oxidant 18, e.g. air, from an oxidant supply 20 and compresses the oxidant 18 for delivery into the combustor 14. The oxidant 18 may be, for example, air, oxygen, oxygen-enriched air, oxygen-reduced air, or any other suitable oxidant. The following discussion refers to air 18 as the oxidant, but is intended only as a non-limiting example.

The combustor 14 receives pressurized fuel 22 from one or more fuel gas compressors 24 within a fuel supply system 26. As described in greater detail below, the fuel supply system 26 includes an electromechanical machine (EM) 28 that may operate or function as a motor for rotating a shaft 30 coupled to the one or more fuel gas compressors 24, thereby driving the one or more fuel gas compressors 24. Additionally or alternatively, the EM 28 may operate or function as a generator driven by the shaft 30 to produce electrical power.

The mixture of the air 18 and the fuel 22 is combusted into hot combustion gases 23 within the combustor 14. These combustion gases 23 flow into the turbine 16 and force turbine blades 32 to rotate, thereby driving the shaft 30 (e.g., turbine shaft) into rotation. The rotation of the shaft 30 provides energy for the compressor 12 to pressurize the air 18. More specifically, the shaft 30 rotates compressor blades 34 attached to the shaft 30 within the compressor 12, thereby pressurizing the air 18. In addition, the rotating shaft 30 may rotate or drive a load 36 coupled to the shaft 30, such as an electrical generator or any device capable of utilizing the mechanical energy of the rotating shaft 30. For example, the load 36 may be a main generator for the gas turbine system 10, and may produce power for an electrical grid. After the turbine 16 extracts work from the combustion products 23, the combustion products 23 may be routed to a heat recovery steam generator (HRSG) 38. The HRSG 38 may, for example, recover waste heat from the combustion products 23 using heat exchangers and the like to produce steam.

As mentioned above, the rotating shaft 30 may be used to drive the fuel gas compressor 24. The fuel gas compressor 24 receives the fuel 22 from a fuel supply 40, as illustrated. For example, the fuel 22 may include syngas, natural gas, methane, or any other gaseous or liquid fuel. The fuel 22 may enter the fuel gas compressor 24 through a plurality of inlet guide vanes (IGVs) 42, which may be used to control a flow rate of the fuel 22 into the fuel gas compressor 24. More specifically, the pitch of the IGVs 42 may be varied, which throttles the inlet flow of the fuel 22 into the fuel gas compressor 24. Within the fuel gas compressor 24, the rotation of compressor blades 44 coupled to the shaft 30 pressurizes the fuel 22 for delivery to the combustor 14.

During transient operation (e.g., partial-load or start-up operation), the rotating speed of the shaft 30 may be insufficient to pressurize the fuel 22 to a desired level or pressure. Accordingly, the electromechanical machine 28 may be operated as a motor to rotate the shaft 30 and drive the fuel gas compressor 24. More specifically, an electric current (e.g., alternating current) may be supplied to the electromechanical machine 28, thereby creating a rotating magnetic field that rotates the shaft 30. In certain embodiments, the EM 28 may be a synchronized motor that rotates the shaft with a fixed speed.

As the gas turbine system 10 continues to start up, flow rates of the air 18 and the fuel 22 increase, and the energy extracted from the combustion products 23 also increases. Accordingly, the rotating speed of the shaft 30 increases. More specifically, a greater flow rate of the air 18 and the fuel 22 increases the flow rate, temperature, and pressure of the combustion products 23 to the turbine 16, thereby rotating the turbine blades 32 more quickly and the rotating speed of the shaft 30. Once the speed of the shaft 30 increases above the fixed speed of the EM 28, the EM 28 begins producing electrical power from the rotation of the shaft 30. In other words, the EM 28 operates as a generator driven by the shaft 30 when the speed of the shaft 30 is greater than the fixed speed of the EM 28. Thus, during normal operation, the gas turbine system 10 may produce electrical power using the EM 28, as well as the load 36 (e.g., main electrical generator). Furthermore, as will be discussed in detail below, the EM 28 (e.g., main electrical generator) and the load 36 may produce power at similar or different frequencies.

It should be appreciated that other types of electromechanical machines may be used. For example, the EM 28 may be an induction motor that rotates the shaft 30 with a variable speed. The variable speed of the EM 28 may be based on a power or current input to the EM 28. As the gas turbine system 10 starts up, the power input to the EM 28 may be increased, thereby increasing the rotating speed of the shaft 30. Furthermore, the flow rates of the air 18 and the fuel 22 may be increased, thereby producing a greater flow of the combustion products 23. The greater flow of the combustion products 23 causes the turbine blades 32 to rotate faster, thereby increasing the rotating speed of the shaft 30. Once the flow of the combustion products 23 is sufficient to drive the shaft 30 without the rotation provided by the EM 28, the power input to the EM 28 may be decreased. That is, the EM 28 may be driven by the greater speed of the shaft 30, thereby producing electrical power.

A controller 46 is communicatively coupled to the turbine 16, the fuel gas compressor 24, and the EM 28. The controller 46 regulates operation of the gas turbine system 10 by, for example, controlling application of power to the EM 28. As noted earlier, it may be desirable to selectively operate the EM 28 as a motor to drive the shaft 30 or as a generator driven by the shaft 30 to produce electrical power. For example, a low and/or fixed speed (e.g., a fixed speed provided by a synchronized motor) of the shaft 30 may be indicative of a transient or start-up operation of the gas turbine system 10. The controller 46 may execute instructions to apply electrical power to the EM 28 and to operate the EM 28 as a motor, thereby driving the fuel gas compressor 24 during a startup mode of operation. In a similar manner, a higher speed (e.g., greater than 40, 50, or 60 percent of the rated speed) may be indicative of a steady-state or full-load operation of the gas turbine system 10. Accordingly, the controller 46 may execute instructions to decrease electrical power to the EM 28 and to operate the EM 28 as a generator, thereby producing electrical power during a steady-state mode of operation.

The electrical power produced by the EM 28 may be real power (e.g., power produced from the mechanical torque and routed to a power grid), virtual power (e.g., electromechanical energy stored within the EM 28 itself), or both. For example, the EM 28 may include components such as batteries, capacitors, and the like to store virtual power. Additionally or alternatively, the electromechanical energy may be stored within the magnetic fields generated by the EM 28. The virtual power may be converted into real power when desirable. For example, the gas turbine system 10 may be restarted after a trip or shutdown. Virtual power within the EM 28 may be converted into mechanical torque and used to drive the shaft 30, even without applying current from an external source to the EM 28. Such an arrangement may improve the reliability and operability of the gas turbine system 10.

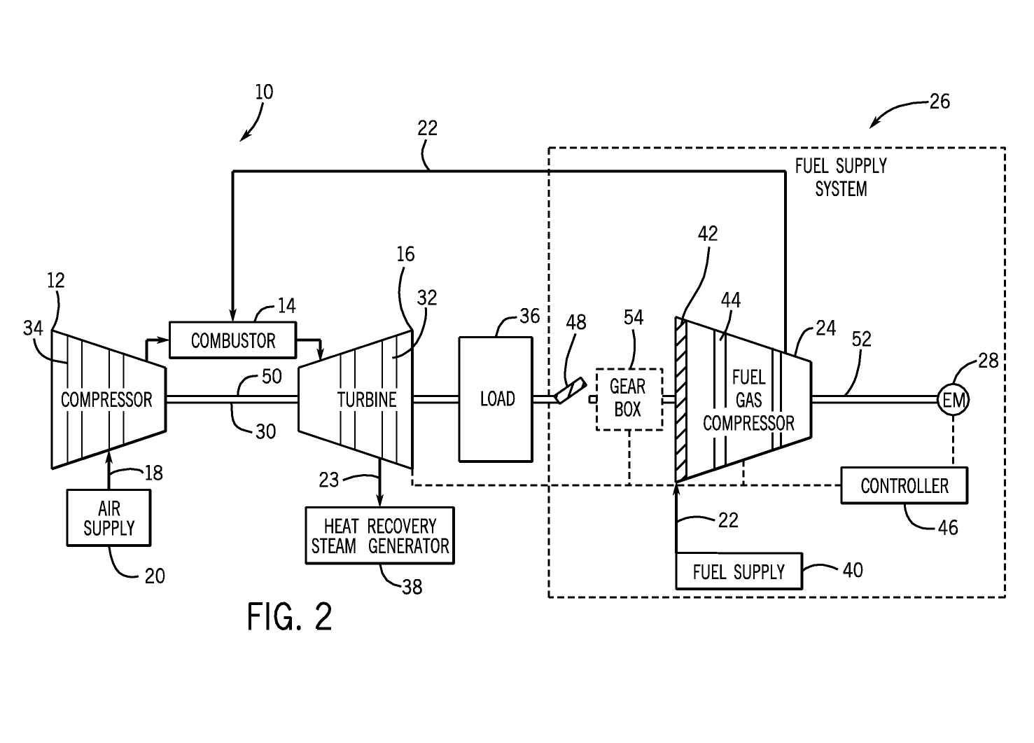

FIG. 2 illustrates another embodiment of the gas turbine system 10 having the electromechanical machine 28 that may selectively operate or function as a motor or a generator to improve the efficiency of the gas turbine system 10. As shown, the gas turbine system 10 further includes a clutch 48 that divides the shaft 30 into a turbine shaft 50 coupled to the turbine blades 32 and a fuel gas compressor shaft 52 coupled to the blades 44 of the fuel gas compressor 24. The clutch 48 enables the turbine shaft 50 and the fuel gas compressor shaft 52 (e.g., motor shaft) to be driven separately and independently of one another. For example, during start-up or transient operation, the clutch 48 may be disengaged. The EM 28 may then drive the fuel gas compressor 24 and the fuel gas compressor shaft 52 (i.e., operate as a motor) while the combustion products 23 separately and independently drive the turbine 16 and the turbine shaft 50. Because the EM 28 may drive fewer components of the gas turbine system 10, such an arrangement may reduce the power consumption of the EM 28 during start-up of the gas turbine system 10. Furthermore, the clutch 48 enables the turbine shaft 50 and the compressor shaft 52 to be driven at different speeds while the clutch 48 is disengaged.

When the clutch 48 is engaged, the turbine shaft 50 and the fuel gas compressor shaft 52 are coupled together. The coupled shafts may behave similarly to the shaft 30 of FIG. 1. That is, when the clutch 48 is engaged, the EM 28 may operate as a generator driven by the turbine shaft 50. In certain embodiments, the clutch 48 may be engaged when the rotating speed of the turbine shaft 50, the fuel gas compressor shaft 52, or both, are sufficiently high. Thus the controller 46 may monitor the speed of the respective shafts 50 and 52 to control the position of the clutch 48. Furthermore, the controller 46 may monitor a myriad of operating conditions, such as respective speeds of the shafts 50 or 52, a pressure of the fuel 22 (e.g., at an outlet of the fuel gas compressor 24), a flow rate of the fuel 22, a temperature of the combustor 14, or any combination thereof, to determine when the clutch 48 may be engaged or disengaged. In summary, the EM 28 may operate or function as a motor (e.g., synchronized fixed-speed motor or variable-speed induction motor) when the clutch 48 is disengaged, and the EM 28 may operate or function as a generator when the clutch 48 is engaged.

As shown in FIG. 2, the gas turbine system 10 may also include a gearbox 54. The gearbox 54 includes one or more gears and/or gear trains that enable the turbine shaft 50 and the fuel gas compressor shaft 52 to rotate at different speeds, even when the shafts 50 and 52 are coupled together. More specifically, the turbine shaft 50 may be coupled to one or more gears that enables rotation of the fuel gas compressor shaft 52 (e.g., motor shaft) to be scaled up or down by a certain ratio. In certain embodiments, a ratio of shaft speeds between the driving shaft (e.g., the turbine shaft 50) and the driven shaft (e.g., the fuel gas compressor shaft 52) may be between approximately 10:1 to 1:10, 5:1 to 1:5, 2:1 to 1:2, and all subranges therebetween. In certain embodiments, the gear ratio may be 1:1. Furthermore, the gear ratio may be adjustable during operation of the gas turbine system 10 using, for example, the controller 46. Because the gear box enables the turbine shaft 50 and the fuel gas compressor shaft 52 to rotate at different speeds, the load 36 and the EM 28 may generate power with different frequencies. For example, the turbine shaft 50 may rotate at a frequency of 60 Hz, and the load 36 may produce electrical power with a frequency of approximately 60 Hz. When a gear ratio of 1:2 is selected, the fuel gas compressor shaft 52 may rotate at a frequency of 120 Hz, and the EM 28 may produce electrical power at a frequency of approximately 120 Hz. Thus, the gas turbine system 10 may generate real or virtual power for a variety of different applications.

The desired gear ratio may be selected based on an operating condition of the gas turbine system 10. For example, a lower gear ratio may be desirable during normal operation, in order to improve the efficiency of the fuel supply system 26. However, a higher gear ratio may be more efficient during startup, when the speeds of the turbine shaft 50 and the fuel gas compressor shaft 52 are generally lower. Thus, the controller 46 may select a gear ratio based on an operating condition or operating mode of the gas turbine system 10 in order to increase the efficiency of the gas turbine system 10.

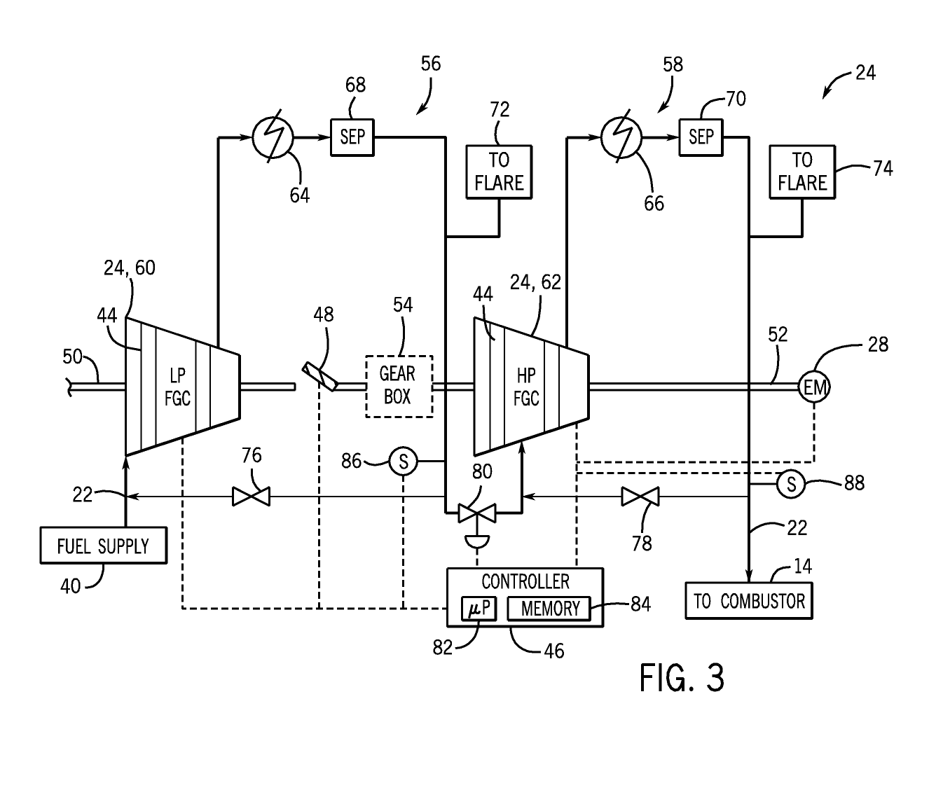

Although the embodiment illustrated by FIG. 2 shows a single fuel gas compressor 24, it should be noted that the fuel supply system 26 may employ multiple fuel gas compressors 24. For example, the fuel 22 may be compressed to an intermediate pressure by a first fuel gas compressor and subsequently compressed to a higher pressure using a second fuel gas compressor. Multiple stages of compression may increase the output pressure of the fuel 22 as well as the efficiency of the fuel supply system 26. Thus, certain embodiments of the fuel supply system 26 may include 1, 2, 3, 4, or more fuel gas compressors 28 connected in series or parallel, as will be discussed further below with respect to FIG. 3.

FIG. 3 illustrates an embodiment of the fuel supply system 26 having two stages of compression (e.g., a first stage of compression 56 and a second stage of compression 58). The first stage of compression 56 includes a low pressure (LP) fuel gas compressor 60 (e.g., 24) that is coupled to the turbine shaft 50. The second stage of compression 58 includes a high pressure (HP) fuel gas compressor 62 (e.g., 24) that is coupled to the fuel gas compressor shaft 52. Thus, as noted earlier, the compressors 60 and 62 may be controlled independently based on the position of the clutch 48 and may rotate at different speeds. More specifically, when the clutch 48 is disengaged, the HP fuel gas compressor 62 may be driven by the fuel gas compressor shaft 52, whereas the LP fuel gas compressor 60 may be driven by the turbine shaft 50. Alternatively, EM 28 can drive both HP fuel gas compressor 62 and LP fuel gas compressor 60 when clutch 48 is engaged.

The fuel 22 from the fuel supply 40 is compressed by the low pressure fuel gas compressor 60 and then is further compressed by the high pressure fuel gas compressor 62. After the first and second stages of compression 56 and 58, the fuel 22 is cooled within respective coolers 64 and 66. For example, the coolers 64 and 66 may be finned tube heat exchangers that that cool the fuel 22 using cooling water, refrigerant, or another cooling fluid. As will be appreciated, certain fuels 22 may include one or more condensable components (e.g., steam, hydrocarbons, sulfides). When the fuel 22 is cooled, these components may condense into a liquid form. Accordingly, separators 68 and 70 (e.g., gas-liquid separators) are disposed along the fuel flow path in each of the first and second stages of compression 56 and 58 in order to separate the liquid condensate from the remaining vapor fuel 22. For example, the separators 68 and 70 may be gravity separators, inertial separators, centrifugal separators, mesh screens, and/or the like.

Flares 72 and 74 are also disposed along the flow path of the fuel 22 in the first and second stages of compression 56 and 58. The flares 72 and 74 enable pressure control of the fuel supply system 24 by, for example, venting a portion of the fuel 22 when the pressure is too high. The pressure of the fuel supply system 24 may also be controlled by spillback valves 76 and 78. More specifically, opening the spillback valves 76 or 78 enables a portion of the fuel gas compressor 24 discharge to flow back to the fuel gas compressor 24 inlet, thereby increasing the discharge pressure of the respective fuel gas compressors 60 and 62. In addition, certain fuel gas compressors may start-up in a full spillback mode, wherein the entirety of the fuel gas compressor discharge is circulated back to the fuel gas compressor inlet.

A control valve 80 is disposed between the fuel gas compressors 60 and 62. Depending on the operating mode of the combustor 14, it may be desirable to increase or decrease the flow of the fuel 22. For example, during start-up operation, the flow of fuel 22 is gradually increased as the gas turbine system 10 starts up. During turndown operation, the flow of the fuel 22 may be gradually decreased. Additionally, during normal operation, the flow rate of the fuel 22 may be adjusted slightly in order to maintain stable operating conditions within the combustor 14. Thus, the control valve 80 may be throttled as desired in order to adjust the flow rate of the fuel 22. In certain embodiments, the control valve 80 may be adjusted by the controller 46.

As discussed above, the function of the EM 28 may depend on the position of the clutch 48. For example, during transient or start-up operation, the clutch 48 may be disengaged. Accordingly, the EM 28 may operate as a motor to drive the HP fuel gas compressor 62. When the clutch 48 is disengaged, the LP fuel gas compressor 60 may be driven by the turbine shaft 50. During steady-state or full-load operation, the clutch 48 may be engaged, coupling the turbine shaft 50 to the fuel gas compressor shaft 52. As such, the turbine shaft 50 may drive the LP fuel gas compressor 60 and the HP fuel gas compressor 62, and the EM 28 may operate as a generator and may also be driven by the turbine shaft 50 to generate electrical power.

In order to control the position of the clutch 48 as well as the function of the EM 28, the controller 46 includes a processor 82 and memory 84 to execute instructions. These instructions may be encoded in software programs that may be executed by the processor 82. Further, the instructions may be stored in a tangible, non-transitory, computer-readable medium, such as the memory 84. The memory 84 may include, for example, volatile or nonvolatile memory, random-access memory, read-only memory, hard drives, and the like.

The controller 46 is communicatively coupled to each of the fuel gas compressors 60 and 62, the clutch 48, the control valve 80, and sensors 86 and 88. The sensors 86 and 88 detect and/or measure one or more operating conditions associated with the respective stages of compression 56 and 58. In certain embodiments, the sensors 86 and 88 may detect operating conditions related to operation of the gas turbine system 10. For example, the sensors 86 and 88 may detect a flow rate of the fuel 22, a pressure of the fuel 22, a temperature of the fuel 22, a speed of the shafts 50 and 52, vibration of the fuel gas compressors 60 and 62, and the like. The controller 46 may adjust the position of the clutch 48, the power supplied to the EM 28, and/or the operating mode of the EM 28 (e.g., motor or generator operation) based on the operating conditions detected and/or measured by the sensors 86 and 88.

In certain embodiments, the sensors 86 and 88 may detect rotational speeds of the turbine shaft 50 and/or the fuel gas compressor shaft 52 as an indication of the operating mode of the gas turbine system 10. For example, when the speed of the turbine shaft 50 is less than a threshold (e.g., approximately 60, 50, or 40 percent of the rated speed), the controller 46 may determine that the gas turbine system 10 is in a start-up or turndown mode. In such circumstances, the controller 46 may disengage the clutch 48 and operate the EM 28 as a motor to drive the HP fuel gas compressor 62. This configuration enables the fuel 22 to be adequately pressurized for delivery to the combustor 14, even though the speed of the turbine shaft 50 is relatively low.

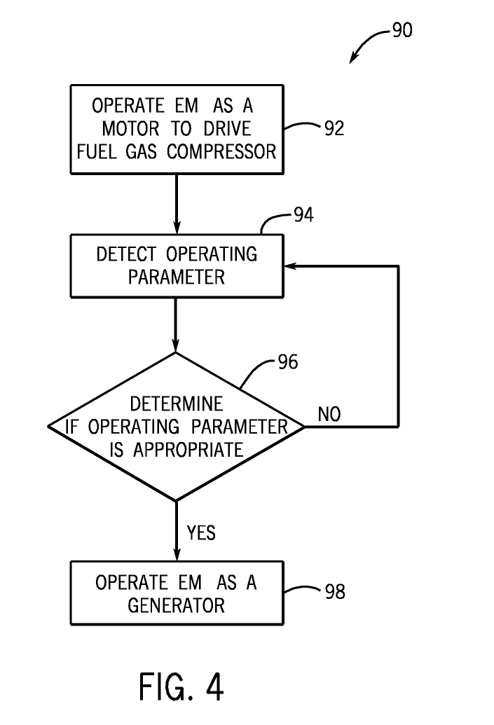

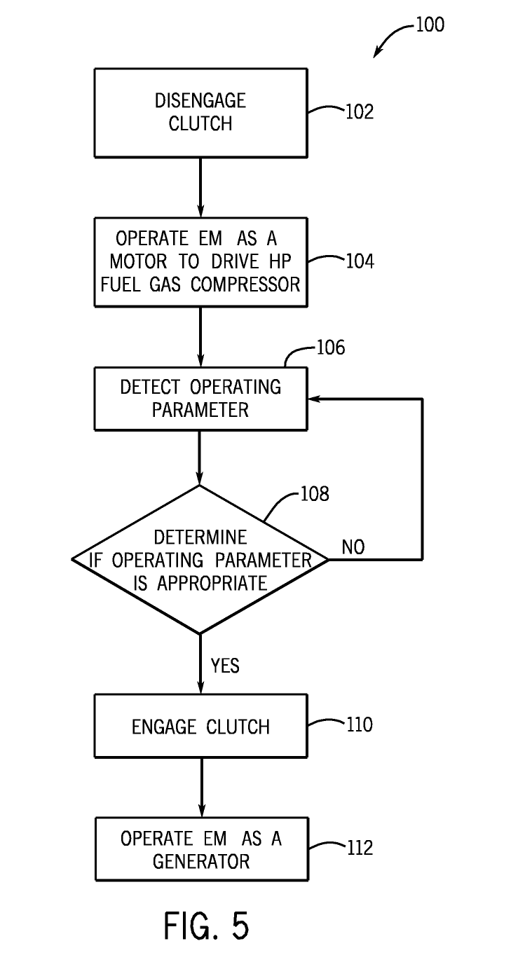

When the speed of the turbine shaft 50 increases above a threshold (e.g., approximately 40, 50, or 60 percent of the rated speed), it may be desirable to engage the clutch 48 and operate the EM 28 as a generator. In certain embodiments, the threshold turbine shaft 50 speeds may be different. For example, the controller 46 may engage or disengage the clutch 48 when the speed of the turbine shaft 50 is between approximately 10 to 90, 20 to 80, or 30 to 70 percent of the rated speed. Additionally or alternatively, the controller 46 may control the clutch 48 based on other operating conditions, such as pressures, flows, temperatures, and the like. For example, in response to an alarm or threshold setpoint, the controller 46 may disengage the clutch 48 to decrease the flow rate of the fuel 22 to the combustor 14. The operation of the EM 28 is summarized below with respect to FIGS. 4 and 5.

FIG. 4 is a flowchart of an embodiment of a method 90 to operate the EM 28 to improve the efficiency and operability of the gas turbine system 10. The EM 28 operates (block 92) as a motor to drive the one or more fuel gas compressors 24 during, for example, start-up of the gas turbine system 10. The sensors 86 and 88 detect (block 94) an operating condition that is indicative of an operating mode of the gas turbine system 10. For example, the operating condition may be a speed of the shaft 30, a pressure of the fuel 22, a flow rate of the fuel 22, a temperature of the combustor 14, an exhaust temperature or flow rate, a power output, or other operating parameters. The controller 46 determines (block 96) if the operating condition meets one or more criteria by, for example, comparing the operating condition to a threshold or by determining if the operating condition is within an allowable range. In certain embodiments, if the operating condition (e.g., turbine speed) is greater than the threshold, the controller 46 may determine (block 96) that the operating condition meets the one or more criteria. When the operating condition meets the one or more criteria, the EM 28 is operated (block 98) as a generator driven by the shaft 30 (e.g., in a generator mode) to generate real power, virtual power, or both. However, if the operating condition does not meet the one or more criteria (e.g., the operating condition is outside of an allowable range), the EM 28 may continue to operate (block 92) as a motor (e.g., in a motor mode) until the operating condition satisfies the one or more criteria.

FIG. 5 is a flow chart of another embodiment of a method 100 to operate the EM 28 depending on the position of the clutch 48. The controller 46 may execute instructions to disengage (block 102) the clutch 48. As explained earlier, the decision to disengage (block 102) the clutch 48 may be based on an operating mode (e.g., start-up or transient operation) of the gas turbine system 10. The EM 28 operates (block 104) as a motor, thereby driving the HP fuel gas compressor 62. While the EM 28 operates (block 104) as a motor, the sensors 86 and 88 detect (block 106) an operating parameter associated with each stage of compression 56 and 58 (e.g., see FIG. 3). The controller 46 determines (block 108) if the operating condition meets one or more criteria by, for example, comparing the operating condition to an allowable range. Furthermore, when the operating condition meets the one or more criteria (e.g., the operating condition is within the allowable range), the controller 46 may execute instructions to engage (block 110) the clutch 48. The EM 28 may operate (block 112) as a generator driven by the turbine shaft 50 to produce electrical power. However, when the operating condition does not meet the one or more criteria (e.g., the operating condition is outside the allowable range), the EM 28 may continue to operate (block 104) as a motor. Furthermore, the clutch 48 may be disengaged (block 102) when the operating condition does not meet the one or more criteria. As will be appreciated, an operating condition being outside of an allowable range may be an indication of a fault, an operating upset, a start-up or shut-down operation, or any combination thereof.

Technical effects of the disclosed embodiments include systems and methods to enable improved startup of gas turbine systems 10. In particular, the EM 28 operates as a motor that drives the fuel gas compressor 24 when the rotating speed of the shaft 30 is low. As the gas turbine system 10 continues to start up, the rotational speed of the shaft 30 gradually increases. Once the speed of the shaft 30 is sufficiently high to adequately pressurize the fuel 22 at a desired amount or level, the EM 28 may be operated as a generator driven by the shaft 30, thereby producing electrical power. The selective operation of the EM 28 as either a motor or a generator, based on an operating condition or mode of the gas turbine system 10, improves the efficiency and operability of the gas turbine system 10. Furthermore, because the EM 28 may operate as a generator during steady-state operation, the size of the load 36 (e.g., main generator) may be decreased.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gas turbine system, comprising:
a compressor configured to compress an oxidant;
at least one fuel gas compressor configured to compress fuel;
a combustor configured to combust a mixture of the oxidant and the fuel into combustion products;
a turbine configured to rotate a shaft using the combustion products, wherein the shaft is coupled to the compressor, the at least one fuel gas compressor, and the turbine; and
an electromechanical machine configured to selectively operate as a motor to drive the shaft in a motor mode and to operate as a generator driven by the shaft to generate power in a generator mode, based on an operating condition of the gas turbine system.

2. The gas turbine system of claim 1, wherein the electromechanical machine is a synchronized motor.

3. The gas turbine system of claim 1, wherein the electromechanical machine is configured to produce electrical power, virtual power, or both, in the generator mode.

4. The gas turbine system of claim 1, wherein the operating condition comprises a rotational speed of the shaft, an output pressure of the fuel, a flow rate of the fuel, or any combination thereof.

5. The gas turbine system of claim 1, comprising a main generator coupled to the shaft and configured to generate power using the shaft.

6. The gas turbine system of claim 1, wherein the at least one fuel gas compressor comprises a low pressure fuel gas compressor and a high pressure fuel gas compressor fluidly coupled together in series.

7. The gas turbine system of claim 1, comprising a clutch disposed along the shaft and configured to divide the shaft into a turbine shaft and a motor shaft, wherein the turbine is configured to drive the turbine shaft and the electromechanical machine is configured to drive the motor shaft when the clutch is disengaged.

8. The gas turbine system of claim 7, comprising a gear box disposed along the shaft and configured to enable the turbine shaft and the motor shaft to rotate with different rotational speeds when the clutch is engaged.

9. The gas turbine system of claim 1, comprising:
a sensor configured to measure the operating parameter; and
a controller configured to regulate operation of the electromechanical machine as either the motor or the generator based on a measurement of the operating parameter.

10. A system, comprising:
a fuel supply system, comprising:
a first fuel gas compressor coupled to a fuel gas compressor shaft and configured to pressurize a fuel for a gas turbine system;
a clutch coupled to the fuel gas compressor shaft and configured to selectively engage the fuel gas compressor shaft with a turbine shaft of the gas turbine system; and
an electromechanical machine configured to selectively operate as a motor to drive the fuel gas compressor shaft in a motor mode and to operate as a generator driven by the turbine shaft to generate power in a generator mode, based on an operating condition of the gas turbine system.

11. The system of claim 10, wherein the electromechanical machine is configured to operate as the motor when the clutch is disengaged.

12. The system of claim 10, wherein the electromechanical machine is configured to operate as the generator when the clutch is engaged.

13. The system of claim 10, wherein the electromechanical machine is a synchronized motor.

14. The system of claim 10, comprising the gas turbine system, wherein the gas turbine system comprises:
a compressor configured to compress an oxidant;
a combustor configured to combust a mixture of the oxidant and the fuel into combustion products; and
a turbine configured to rotate the turbine shaft using the combustion products.

15. The system of claim 10, comprising a second fuel gas compressor coupled to the turbine shaft and configured to pressurize the fuel sequentially or in parallel with the first fuel gas compressor.

16. A method, comprising:
operating an electromechanical machine as a motor to drive a fuel gas compressor shaft of a fuel gas compressor;
detecting an operating parameter related to gas turbine operation using a sensor;
determining if the operating parameter is within a range; and
operating the electromechanical machine as an auxiliary generator driven by the shaft when the operating parameter is within the range.

17. The method of claim 16, wherein the operating parameter comprises a rotational speed of the shaft, an output pressure of a fuel, a flow rate of the fuel, or any combination thereof.

18. The method of claim 16, comprising:
disengaging a clutch to decouple the fuel gas compressor shaft from a turbine shaft and operating the electromechanical machine as the motor when the operating parameter is outside of the range; and
engaging the clutch to couple the fuel gas compressor shaft to the turbine shaft and operating the electromechanical machine as the auxiliary generator when the operating parameter is within the range.

19. The method of claim 18, comprising generating power using a main generator driven by the turbine shaft.

20. The method of claim 19, comprising driving the main generator and the auxiliary generator at different speeds using a gearbox to generate power at different frequencies.
